(19) United States
(12) Patent Application Publication
(10) Pub. No.: US 2011/0193974 A1
(43) Pub. Date: Aug. 11, 2011

(54) Electronic camera having a communication function

(75) Inventors: Norikazu Yokonuma, Tokyo (JP); Masaki Hayashi, Kawasaki-shi (JP); Daiki Tsukahara, Tokyo (JP)

(73) Assignee: NIKON CORPORATION, Tokyo (JP)

(21) Appl. No.: 13/064,781

(22) Filed: Apr. 14, 2011

Related U.S. Application Data
(63) Continuation of application No. 11/806,210, filed on May 30, 2007, now abandoned.
Application No. 11/806,210 is a continuation of application No. 10/660,550, filed on Sep. 12, 2003, now abandoned.
Application No. 10/660,550 is a continuation of application No. 09/081,784, filed on May 20, 1998, now abandoned.
(60) Provisional application No. 60/056,300, filed on Aug. 29, 1997.

(30) Foreign Application Priority Data
Jun. 6, 1997 (JP) 09-149314
Jun. 6, 1997 (JP) 09-149315

(51) Int. Cl. H04N 5/225

(52) U.S. Cl. 348/207.1; 348/E05.024

(57) ABSTRACT

An electronic camera has an image data memory for storing image data and a communication mode for transferring the stored image data to one or more different cameras. The camera includes a controller that, prior to image data transmission, receives remaining capacity data of the image data memory in a receiver side camera and displays an image number corresponding to the remaining capacity of the receiver side camera. When plural receiver side cameras are available, the controller, prior to image data transmission, receives the remaining capacity data of the image data memory in the plurality of receiver side cameras and displays a number of sendable images corresponding to the remaining capacity for each of the plurality of receiver side cameras.

This is a Continuation of application Ser. No. 11/806,210 filed May 30, 2007, which in turn is a Continuation of application Ser. No. 10/660,550 filed Sep. 12, 2003, which in turn is a Continuation of application Ser. No. 09/081,784 filed May 20, 1998, which claims the benefit of U.S. Provisional Application No. 60/056,300 filed Aug. 29, 1997. The disclosure of each the prior applications is hereby incorporated by reference herein in its entirety. The disclosures of the following priority applications are herein incorporated by reference: Japanese Patent Application No. 9-149314 filed Jun. 6, 1997 and Japanese Patent Application No. 9-149315 filed Jun. 6, 1997.

### BACKGROUND OF THE INVENTION

1. Field of Invention

The present invention relates to electronic cameras that record photographed image data to an image data memory, and have a communication function by which image data is transferred between cameras.

2. Description of Related Art

Among electronic cameras, there are electronic still cameras, which photograph still images, and electronic video cameras, which photograph animated (moving) images. The electronic still camera, for example, includes photographic elements such as a CCD (Charged Coupled Device), and photographs an image captured by an optical system. Such cameras can then store the image in an image data memory, which stores the photoelectrically converted image data. Unlike conventional still cameras that expose images on the traditional type of photosensitive film, electronic still cameras can process the image data as digital signals. Thus, editing of the image, transferring, recording and the like can be easily done on (or by) a computer.

Additionally, such cameras can also transfer image data between cameras by connecting plural cameras by a communication cable. In this case, it is possible to transfer the image data simultaneously to a plurality of cameras.

Further, some electronic still cameras can communicate optically using infrared rays, or through a communication cable, and there are also cameras that can transmit image data between cameras. In short, cameras that have mutually interchangeable communication functions are brought together, and are set to be in a two-way optical communication condition. Then, the normally compressed image data in memory is transferred from one camera to the other camera, and then is stored in the image data memory in the other camera.

However, the image data itself, depending on the preciseness (detail) thereof, generally has a large data capacity, which limits the number of images that can be stored in the built-in image data memory of the cameras. Accordingly, when the recordable capacity of the image data memory in the receiver side camera is small, the transmission of image data exceeding the recordable capacity results in a sending (transmission) error.

Further, when the image data is simultaneously transferred to a plurality of cameras, if the recordable capacity in one or more of the receiver side cameras does not satisfy the capacity of the image data that is sent, it causes a transmission error. In order to prevent this from occurring, it is necessary to check the remaining capacity of each camera on the receiver side.

Moreover, when the user wishes to transfer as much image data as possible by selecting the camera within a plurality of cameras, that has a maximum remaining recordable capacity, it is necessary for the user to check the remaining capacity of the receiver side cameras one by one and to start the communication between the cameras after confirming the camera having the maximum capacity. This operation is complicated and time-consuming.

### SUMMARY OF THE INVENTION

One aspect of the present invention is to provide an electronic camera that can prevent the occurrence of a transmission error before the image data is transferred between cameras.

Another aspect of the present invention is to provide an electronic camera that can prevent the transferring of image data beyond the remaining recordable capacity of the image data memory of the receiver side camera when transferring image data between cameras.

Another aspect of the present invention is to provide an electronic camera that can prevent the occurrence of a transmission error before image data is sent to a plurality of receiver side cameras.

Another aspect of the present invention is to provide an electronic camera that can prevent the transferring of image data beyond the remaining recordable capacity of the image data memory of the receiver side when transferring image data to a plurality of cameras.

Yet another aspect of the present invention is to provide an electronic camera that can select a camera that can successfully receive image data that is to be sent.

In order to achieve the above and/or other aspects, an electronic camera receives the remaining capacity data of the image data memory in a receiver side camera before transferring image data, and has a controller that displays the number of images corresponding to the remaining amount (i.e., the capacity) in the image data memory of the receiver side camera. The camera preferably is an electronic still camera that has an image data memory, which records the photographed image data, and a communication function to transfer the image data to a different camera.

Additionally, or alternatively, the electronic camera receives the remaining capacity data of the image data memory in a plurality of receiver side cameras before transferring the image data, and has a controller that displays the number of sendable images, which corresponds to the remaining amount (i.e., the capacity) in the image data memory for each one of the plurality of cameras.

Since the sending camera can know the receivable capacity of the receiving camera (or cameras), it is possible to prevent the transmission of image data that is beyond the sendable (the receivable) capacity.

Additionally, or alternatively, the controller prohibits the selection of image data that is over the transmission capability. For example, transmission is prohibited when image data beyond the remaining capacity of the receiver side camera is selected. Furthermore, the controller can display the number of images that corresponds to the remaining capacity for each of several different types of image data that have different sizes.

### BRIEF DESCRIPTION OF THE DRAWINGS

The invention will be described in conjunction with the following drawings in which like reference numerals designate like elements and wherein:

FIG. 1 is a perspective view of an electronic still camera according to an embodiment of the present invention;

FIG. 2 shows optical communication between two cameras;

FIG. 3 is a block diagram showing the schematic structure of a camera according to an embodiment of the invention;

FIG. 4 illustrates capacity control of the image memory;

FIG. 5 is a flow chart of operations performed by an electronic still camera according to an embodiment of the present invention;

FIG. 6 shows one example of the rear side of a camera, including a display;

FIGS. 7(1)-7(6) show examples of image selection screens during an inter-camera communication mode;

FIG. 8 illustrates transmission of image data between cameras;

FIG. 9 shows optical communication between a transmitting camera and a plurality of receiver side cameras;

FIG. 10 shows another example of the rear side of an electronic still camera of the present invention, including a display;

FIG. 11 is a flow chart of operations performed by a camera according to another embodiment of the invention;

FIGS. 12(1)-12(6) show the change of the display screen during the camera selection mode;

FIGS. 13(1)-13(6) show the display screen when it is set to the image selection mode;

FIG. 14 illustrates the transmission of image data between cameras; and

FIG. 15 shows the condition when one receiver side camera is selected from among three receiver side cameras.

### DETAILED DESCRIPTION OF PREFERRED EMBODIMENTS

Hereafter, embodiments of the present invention are explained in accordance with the drawings. However, the present embodiments are not intended to limit the technical scope of the present invention. The present invention can be widely adopted to electronic cameras (e.g., still or moving), and hereafter the present embodiments are explained by using the electronic still camera as an example.

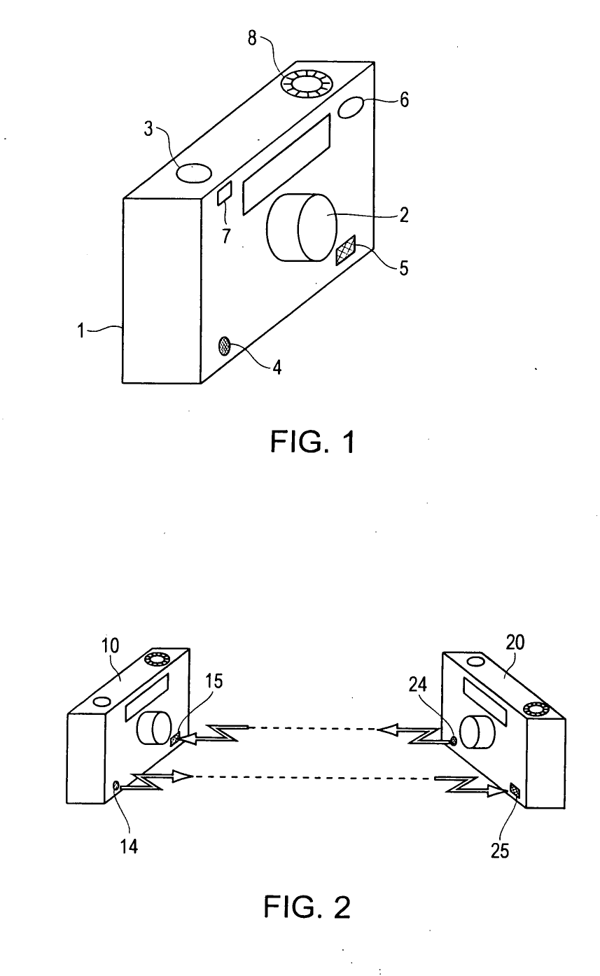

FIG. 1 is a perspective view of the electronic still camera of an embodiment of the present invention. In this example, the electronic still camera 1 has a photography lens 2, a release switch 3, a light transmitter 4 and a light receiver 5 for use in optical communication, a lamp 6 for use in red eye reduction, a self timer display 7, and the like. Additionally, the rear of the camera can have a display screen and other various types of keys, which will be described hereafter. The mode setting key 8 is used to set the photography mode and the communication mode in addition to the ON/OFF of the power.

FIG. 2 shows optical communication between two cameras. As shown in FIG. 2, the sender side camera 10 (the transmitting camera) and the receiver side camera 20 (the receiving camera) are facing each other, and the infrared beam emitted from the optical communication output (transmitter) 14 of the sender side camera 10 is irradiated to the optical communication receiver 25 of the receiving camera 20. Similarly, the infrared beam emitted from the optical communication output 24 of the receiving camera 20 is irradiated onto the optical communication receiver 15 of the transmitting camera 10. Accordingly, communication in both directions is assured by locating the two cameras at positions at which both optical communication transmitters and optical communication receivers are facing each other and both infrared beams are irradiated approximately perpendicular to the direction of the camera front surfaces.

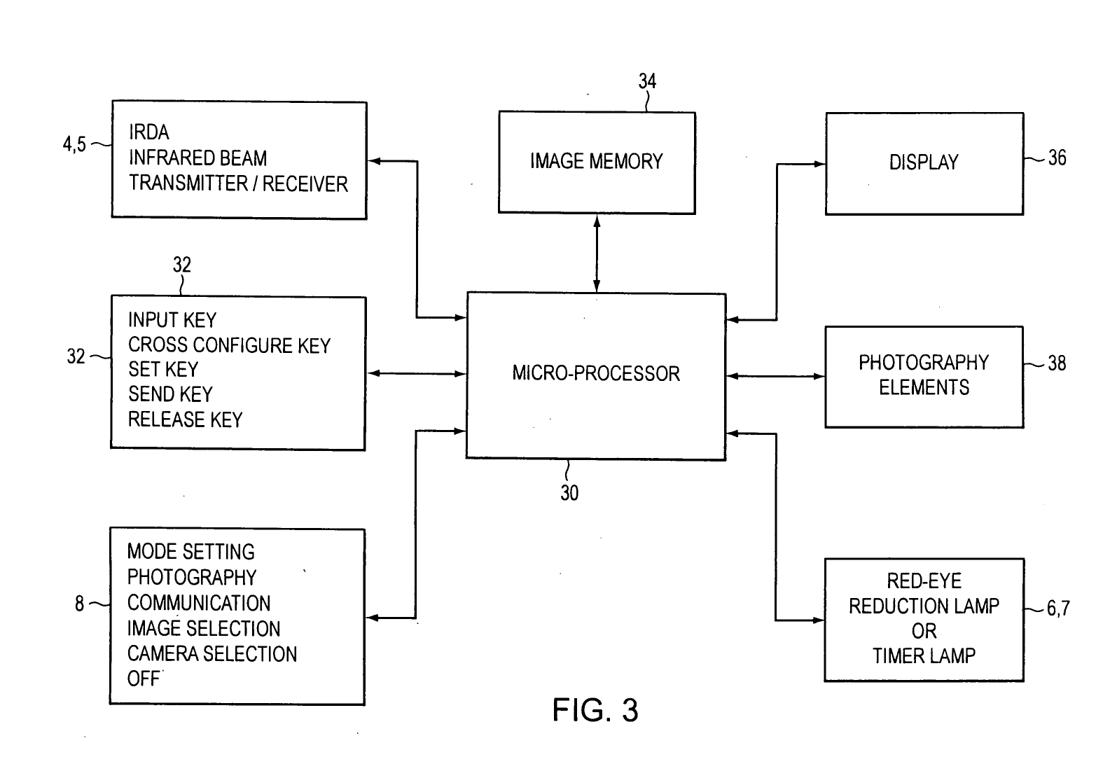

FIG. 3 shows the schematic structure of the inside of each FIG. 2 electronic still camera. The microprocessor 30 has, e.g., one or more control programs for photography, one or more control programs for communication, and the like, and controls the performance of photographing, communication, image selection, camera selection, and the like. In the present embodiment, the communication control program functions to control the performance of image data transmission with respect to a plurality of cameras.

To the microprocessor 30 are connected the optical communication transmitter 4, which performs the sending of the infrared beam, the optical communication receiver 5, which performs the receiving of the infrared beam, a mode setting key 8, and other input keys 32, or the like, which will be described hereafter. Additionally, the microprocessor 30 is connected to photography elements 38, which include a CCD or the like. The photography elements 38 can include other hardware and software such as control programs, lenses (mountable and/or fixed) and the like, as is well known. Image data captured by the CCD is stored in an image memory 34. A semiconductor flash memory (e.g., an EEPROM), for example, can be used for the image memory 34 so that the recorded data will not be lost even when the power is OFF. The aforementioned red eye reduction lamp 6 and self timer lamp 7 are also connected to the microprocessor 30.

The microprocessor 30 uses a control program for the operating mode in response to a mode setting input by the user, and the control program is executed in accordance with the user input, as will be described below. Then, the appropriate display screen is displayed on a display apparatus 36, and/or various actuators are driven.

The above-mentioned transmitter 4 and the receiver 5 for optical communication are connected to microprocessor 30. Accordingly, when communication is executed, the transmitted data from the microprocessor 30 is emitted in the form of an infrared beam from transmitter 4, and any received data, which is received by the receiver 5, is sent to the microprocessor 30.

Any image transmitted through the photography lens 2 is photographed (i.e., captured) by the photography elements 38, such as the CCD, and image data, which is photoelectrically converted, is recorded in the image memory 34 by the microprocessor 30.

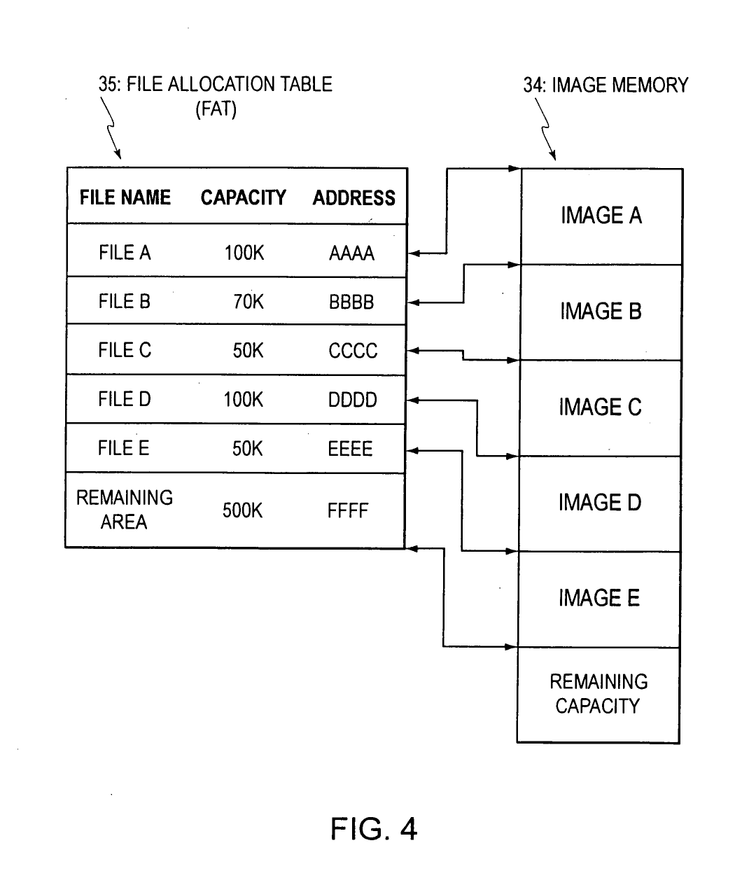

FIG. 4 illustrates the capacity control of the image memory 34. In order to maintain the recorded data even when the power is OFF, a nonvolatile semiconductor memory or the like, for example, is used for the image memory 34. In the example of FIG. 4, the image data of five images, A through E, are stored in the image memory 34. The image data stored in this type of image memory 34 is controlled in the form of files, and controlled by the file allocation table 35. This file allocation table 35 is provided in the control area of the image memory 34, and controls the file name, the capacity of data and the address in the image memory corresponding to each image data file.

For example, the file allocation table 35 is stored in the control area of the image memory 34, and the file names, capacity and address of the images A-E that are stored in the image memory 34 are recorded in the file allocation table 35. The remaining (empty) capacity of the image memory, and the address thereof are also recorded in the file allocation table 35.

Accordingly, when a CALL signal is received at the start of communication, e.g., via optical communication from the transmitting camera, the receiving camera reads out the remaining capacity of the image memory in the receiving camera from its file allocation table 35 and sends it to the transmitting camera along with its own ID data (i.e., it identifies itself and indicates its remaining capacity).

As should be apparent, the sender-side (transmitting) camera and the receiver-side (receiving) camera actually perform two-way communication (i.e., both cameras transmit and receive data). In the context of this description, the sender-side (transmitting) camera is the camera that is seeking to transmit image data (e.g., image files), while the receiver-side (receiving) camera is the camera (or cameras) that are intended to receive image data.

The capacity of the image data is different depending on the density (i.e., resolution and size) of the image and/or the compression method. For example, image data with a high image quality is compressed to approximately 100 KB, image data with an intermediate image quality is compressed to approximately 70 KB, and image data with a low image quality is compressed to approximately 50 KB. Additionally, for example, there are cases when the capacities of the image data files recorded in the image memory are different depending on the compression method. Accordingly, the total number of images recordable in a particular image memory 34 is specified at, for example, A images in the case of all high image quality, B images in the case of all intermediate image quality and C images in the case of all low image quality.

In the example of FIG. 4, the files A and D contain high quality image data, the file B contains image data of intermediate image quality, and files C and E contain image data of low quality. Further, the file allocation table 35 controls the capacity recordable in the image memory 34. In the example of FIG. 4, the remaining capacity is 500 KB. (Thus, from 5 to 10 more image files may be stored therein, depending on their quality levels.)

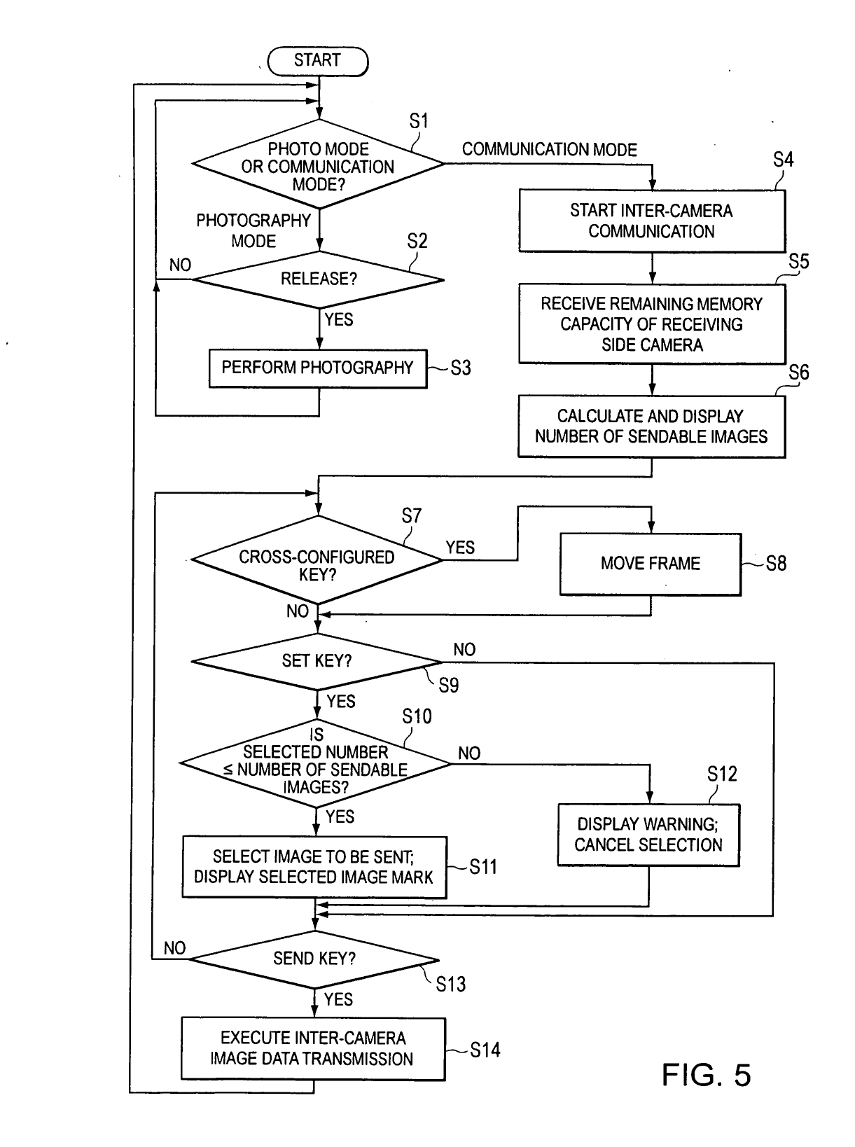

FIG. 5 is a flow chart of procedures used by the electronic still camera of the embodiment of the present invention. In this flow chart, for the convenience of explanation, both flow of the photography mode and the communication mode are described. However, for normal control by a microprocessor, a multitask OS (Operating System) method, for example, is generally adopted. In that case, the tasks for the photography mode and the tasks for controlling communication, etc., can be executed in parallel.

The rear side of the camera is explained before explaining the flow of the communication mode in accordance with the flow chart of FIG. 5.

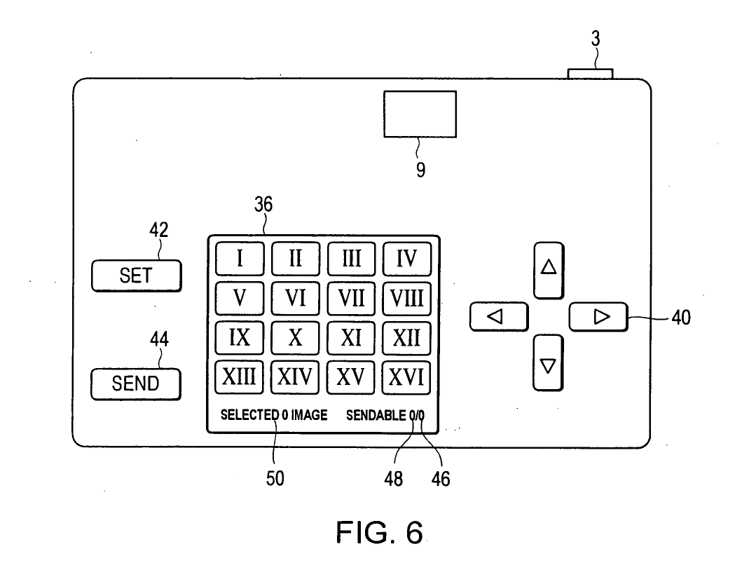

FIG. 6 shows one example of the rear side of a camera. A display screen 36, a viewfinder 9, cross-configured keys 40, a set key 42, a send key 44, and the like are provided on the rear side of the camera. In FIG. 6, the display screen is shown when the communication mode is set by the aforementioned mode set key 8. In this example, the display screen of the display 36 displays 16 images. Additionally, a sendable image number column 46, a selectable image number column 48, and a selected image number column 50 are displayed.

Returning to FIG. 5, as shown in step S1, the setting of the photography mode or the communication mode is set by the mode setting key 8. The system can be set to default to the photography mode, and when there is a response from the release key 3 (step S2), the image transmitted through the photography lens is photographed (step S3).

When set to the communication mode by the mode setting key 8, communication between cameras is started (step S4). At the start of this communication between cameras, according to the embodiment of the present invention, as later-described, the sender side camera 10 sends a call signal CALL along with its sender side ID. In response, the receiver side camera 20 refers to its file allocation table 35, and returns (transmits to the sender side camera) the remaining data capacity of its image memory 34 along with its receiver side ID. This is a basic protocol at the initiation of communication between cameras.

When the remaining capacity of the memory of the receiver side camera (step S5) is received, the sender side camera 10 calculates the number of sendable images according to the remaining capacity of the receiver side camera, and displays it on the display screen 36 as shown in column 46 (step S6).

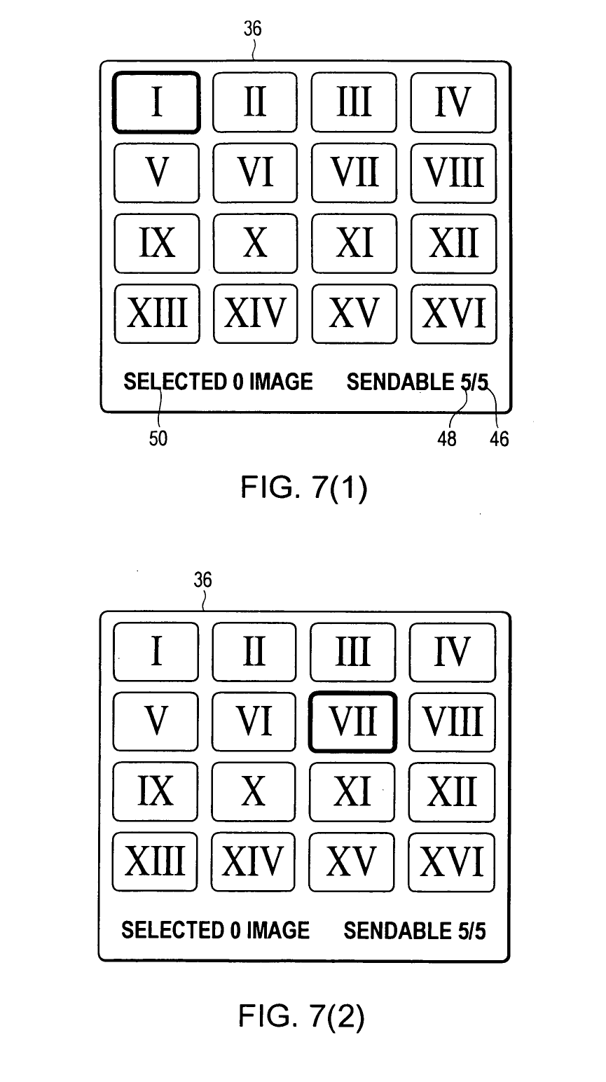

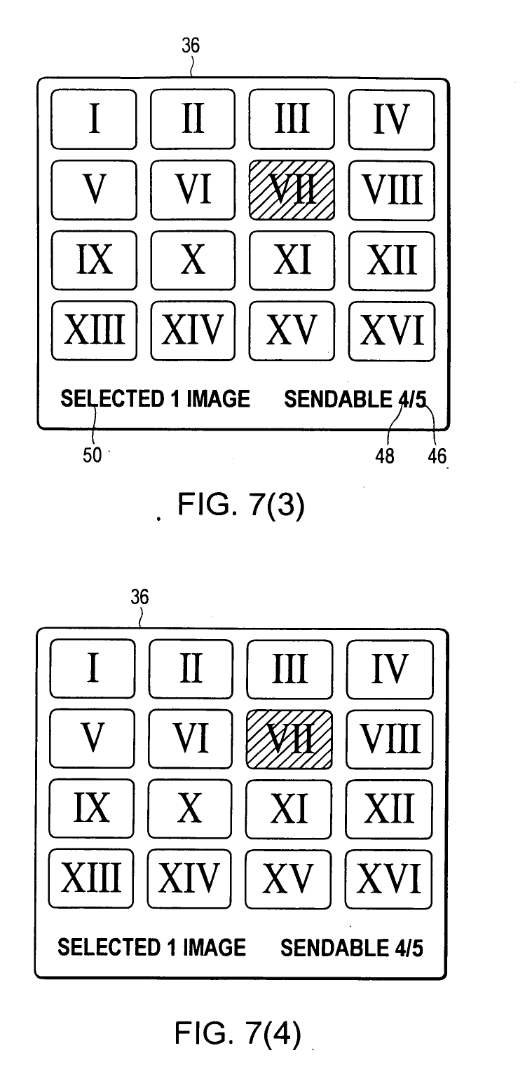

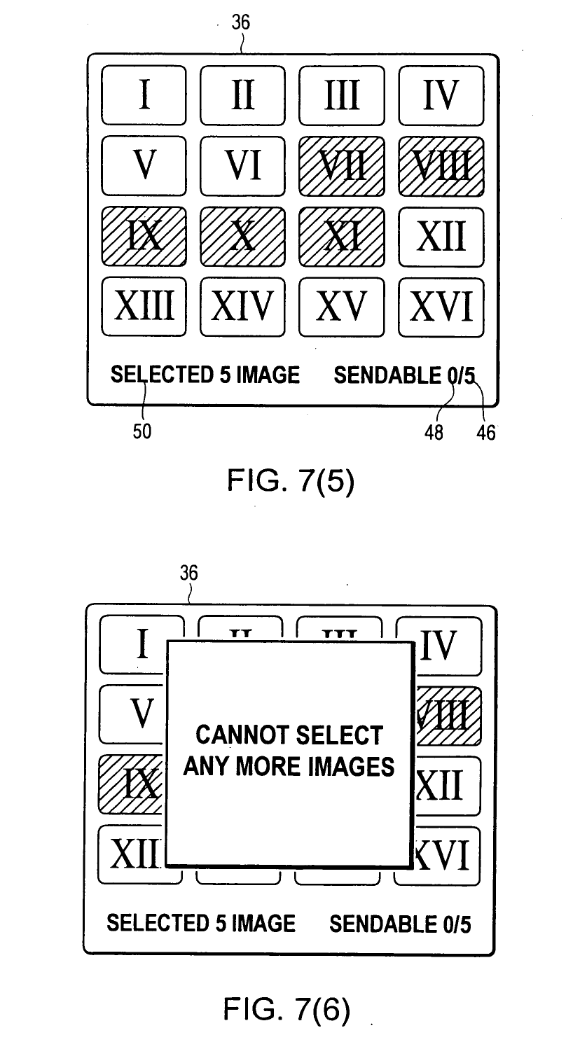

FIGS. 7(1)-7(6) show an example of the image selecting screen during the communication mode between cameras. The control flow chart of FIG. 5 is explained with reference to these figures.

As explained above, the number of sendable images is displayed on the display screen 36 of the sender side camera 10. In the example which is shown in FIG. 7 (1), “5” is displayed in the sendable image number column 46, and “5” is also displayed in the selectable image number column 48. In this example, the number of sendable images, for example, in the case of when three different kinds of image data, i.e., high quality, intermediate quality and low quality exist (in the image memory of the transmitting camera), can be obtained, for example, by determining how many high quality images are recordable in the remaining capacity of the image memory of the receiver side camera. Accordingly, in that case, even though 5 images are indicated as being sendable, when image data having the intermediate quality or the low quality is selected, more than 5 images can be selected.

As another example of displaying the number of sendable images, it is possible, for example, to display as X images of high image quality, Y images of intermediate image quality and Z images of low image quality. In that case, the respective number for high quality, intermediate quality and low quality are all displayed in the sendable image number column 46.

Other examples are also possible. For example, the controller (e.g., the programmed microprocessor 30) can determine the size of the largest image file actually stored in memory (50, 70 or 100 KB in the present example), and determine the number of sendable images based on this determination. The sendable image number also can be updated based on the size of the image files that have been selected. For example, if the sendable image number is originally determined based on an image file size of 100 KB, once two image files having a size of 50 KB are selected, the number of sendable images can be increased by one.

As shown in steps S7 and S8 of FIG. 5, shifting between the 16 image frames is performed by user manipulation of the cross-configured keys 40 of the sender side camera. In short, the frame with the thickened periphery, which shows the selected image is shifted up/down left/right based on operation of the cross-configured keys 40. As shown in FIG. 7(1) to FIG. 7(2), by pressing the cross-configured keys, the frame having the thickened periphery is shifted from the image I to the image VII. If the set key 42 is pressed at this point (step S9), the microprocessor 30, which is the controller, determines whether the selected number of images exceeds the sendable number of images (step S10). If the number of selected images does not exceed the number of sendable images, the image is permitted to be selected for sending, and the display of that image is highlighted (step S11). In the illustrated example, the selected image is shaded, as indicated by the cross-hatching in FIG. 7(3). If the selected number of images exceeds the sendable number of images, for example, as shown in FIG. 7(6), a warning is displayed and the selection of the image is canceled (step S12).

The determination at step S10 of FIG. 5 need not only determine whether the selected number of images exceeds the capacity, but may also determine whether the total capacity (e.g., in KB) of the selected image data exceeds the sendable (receivable) data capacity. However, as for the camera user, it is easier to understand the number of sendable images than the sendable capacity. Accordingly, in the present embodiment, the number of sendable image(s) is(are) displayed on the display 36. In the example shown in FIGS. 7(1)-7(6), image VIII is selected as shown in FIG. 7(4). Then, as shown in FIG. 7(5), a total number of 5, including images IX, X and XI, are selected. When 5 images are selected, “5” is displayed in the column of selected images 50, “0” is displayed on the column 48 of selectable images. Further, if the user tries to select more image(s), as shown in FIG. 7(6), the warning sign of “cannot select any more images” is displayed, and that selection is canceled. This selection cancellation can also be performed by displaying the warning sign indirectly, for example, by the shading not being displayed on the selected image or the like, even when the set key 42 is pressed.

After one or more images are selected by the user, if the send key 44 is pressed (step S13), and the transmission of the image data between cameras is executed (step S14). When the transmission of the image data is completed, the receipt confirmation signal is returned from the receiver side camera 20, and the receipt is confirmed at the sender side camera 10. Since the capacity of the sent image data is less than the remaining capacity in the image memory of the receiver side camera 20, a transmission error due to a lack of capacity of the image memory of the receiver side camera does not occur. Accordingly, the causes of sending error occurrences are limited to a cause that the user easily can determine, such as cut-off of the optical communication during transmission.

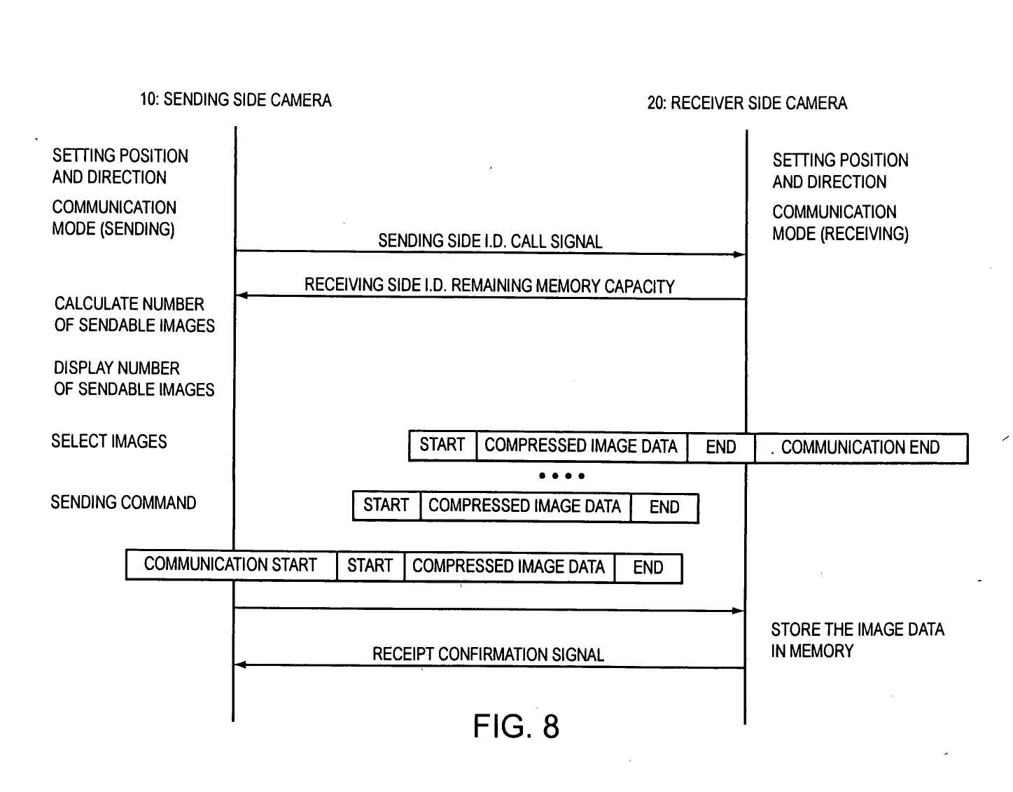

FIG. 8 illustrates transmission of the image data between cameras. The operation of the sender side camera 10 at the left side of the drawing and the receiver side camera 20 at the right side are respectively shown. In the center of the drawing, one example of sending data between both cameras is shown. As explained in order from the top, first, both positions and directions are set (manually) for the sender side camera 10 and the receiver side camera 20, which are placed in the state shown in FIG. 2. Then, the sender side camera 10 is set to the communication mode by operation of the mode setting key 8, and further, it is set to the sending mode by a key not shown in the figure. Similarly, the receiver side camera 20 is set to the communication mode by the mode setting key 8, and further, it is set to the receiving mode by a key not shown in the figure. At this point, the sender side ID and the call signal CALL from the sender side camera 10 are sent to the receiver side camera as the initial protocol of the communication. In response to this, the receiver side camera 20 returns the receiver side camera ID and the data of the remaining capacity in its image memory.

At this point, the sender side camera 10 calculates the number of sendable image(s) and displays the number on the display 36. Then, as stated above, the image(s) is(are) selected, and when the sending command is sent by operation of the send key 44, the transmission of the compressed image data is performed. In this transmission, as shown in FIG. 8, the compressed image data is interposed between the communication start code and the communication end code are sent only for the selected number of images. At the receiver side camera 20, these sent compressed image data are stored in the image memory 34. Receiver side camera 20 sends a receipt confirmation signal to the sender side camera 10 only when it properly receives everything from the communication start code to the communication end code.

In the above-mentioned embodiment, the transfer of the image data between cameras is performed by optical communication that uses infrared beams. However, it is also possible to communicate between cameras connected by a specified cable (either optically, electrically or otherwise).

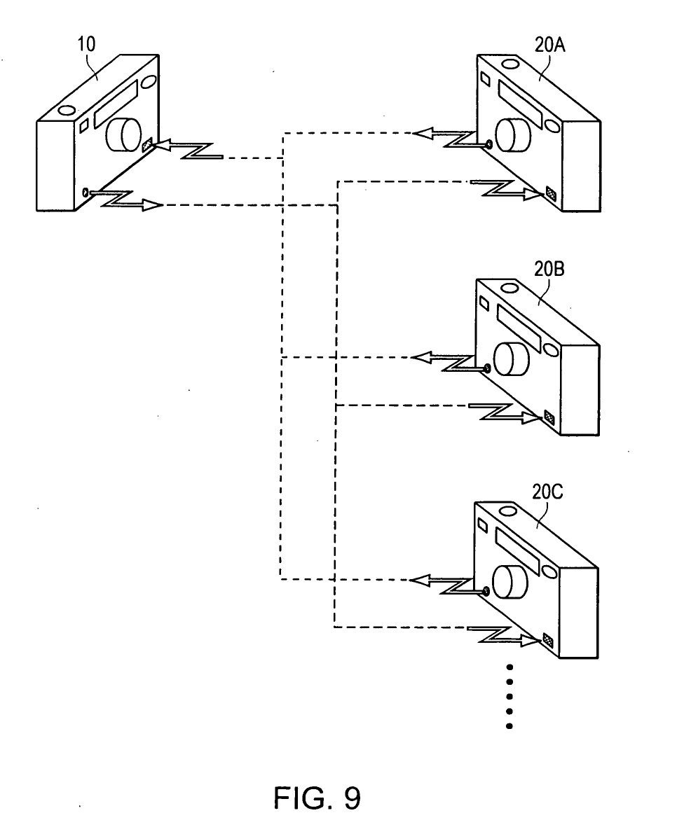

FIG. 9 illustrates an example of performing optical communication with a plurality of receiver side cameras. When the user wishes to transfer the image data to the plurality of receiver side cameras, by making a plurality of receiver side cameras 20A, 20B, 20C, or the like, face the sender side camera 10, it is possible to send the infrared beam between the optical communication output and inputs of the plural cameras, the same way as described above.

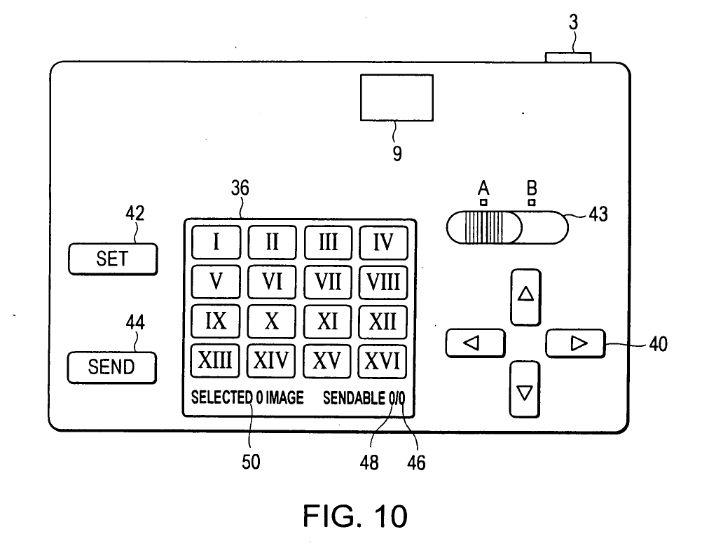

FIG. 10 shows the structure of the rear side of the electronic still camera of this embodiment of the present invention. The release switch 3 is provided on the top of the camera, and, in addition to the viewfinder 9, the display 36, the cross-configured keys 40, the set key 42, the camera selection mode and an image selection mode switching key 43 and the send key 44 are provided at the rear side of the camera. In FIG. 10, as an example, the image selection screen is displayed on the display 36, and icons that identify 16 images (displayed with Roman numerals), the selected image number display column 50, the sendable image number column 46, the selectable image number column 48 and the like are shown.

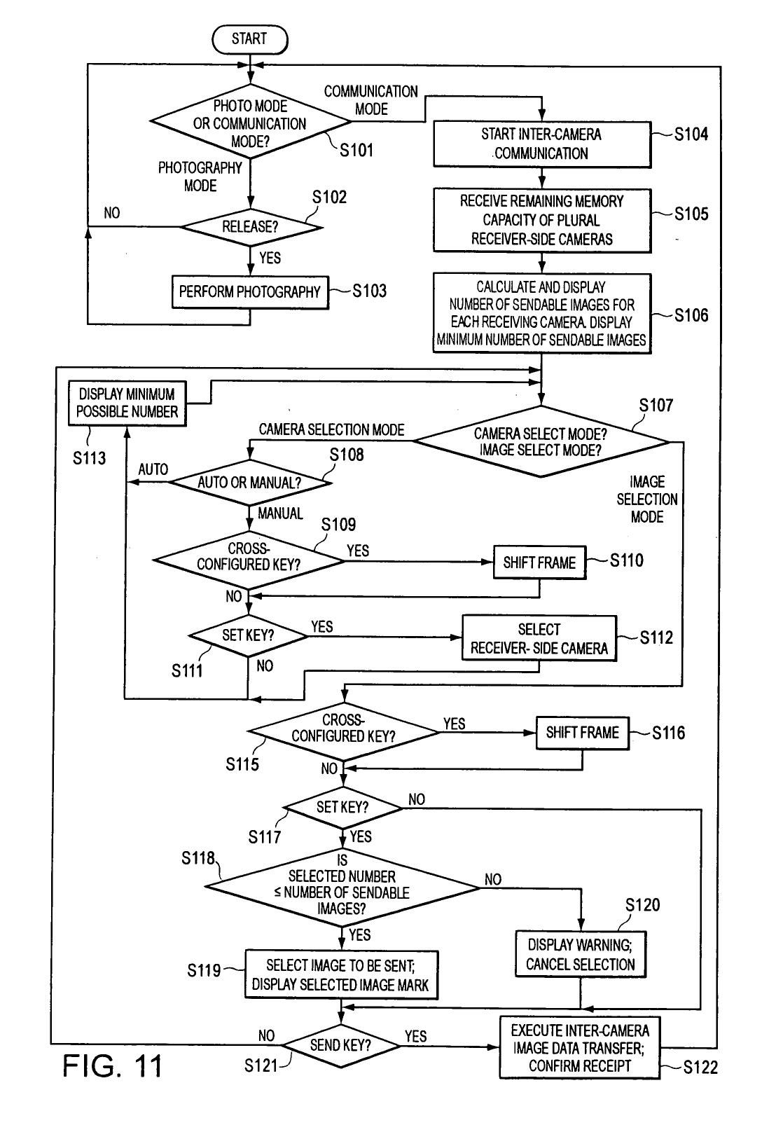

FIG. 11 is a flow chart of procedures used in the present embodiment. According to this flow chart, the operation of the electronic camera of the present embodiment is explained. This flow chart shows the operations performed by the sender side camera. The flow chart is divided into the photography mode (steps S102, S103) and the communication mode (steps S104-S122). The communication mode is divided into the operations when the communication starts (steps S104-S106), the camera selection mode (steps S108-S112) and the image selection mode (steps S115-S122).

Through the mode setting switch 8, which is shown in FIG. 1, the power is turned ON, and the setting of either the photography mode or the communication mode is carried out (step S101). Default can be to the photography mode, and the photography is performed (step S103) after waiting until the release switch 3 is actuated (step S102). The operation of photography is not explained in detail at this point, but the image exposed by photography elements 38, which comprises a CCD, is recorded in the image memory 34 as the image data. Accompanying this, the file name, capacity and address are recorded in the file allocation table 35.

When the transfer of the image data is performed with respect to a plurality of cameras, the sender side camera 10 and the receiver side cameras 20A-20C are oriented by the user as shown in FIG. 9. Then, at the sender side camera, the communication mode is set by the mode setting switch 8 (step S101). Additionally, at the receiver side camera, though not shown in the flow chart, the communication mode is set by the mode setting switch 8. When the receiver side has a plurality of cameras, as described later, unique IDs are given to each of the receiver side cameras by a setting switch, which is not shown, in order to give them individual ID data. For example, camera A, B, C . . . or the like.

When set to the communication mode, in the state of FIG. 9, the camera ID and CALL signal from the sender side camera 10 are sent from the optical communication output 14 by infrared beam communication. This infrared beam signal is received at of the optical communication input 15 of each receiver side camera 20A-20C. In response, the receiver side cameras 20A-20C return the remaining capacity data in their image memory 34 and the ID data time sequentially in order of their given IDs. This becomes the initial communication protocol (step S104).

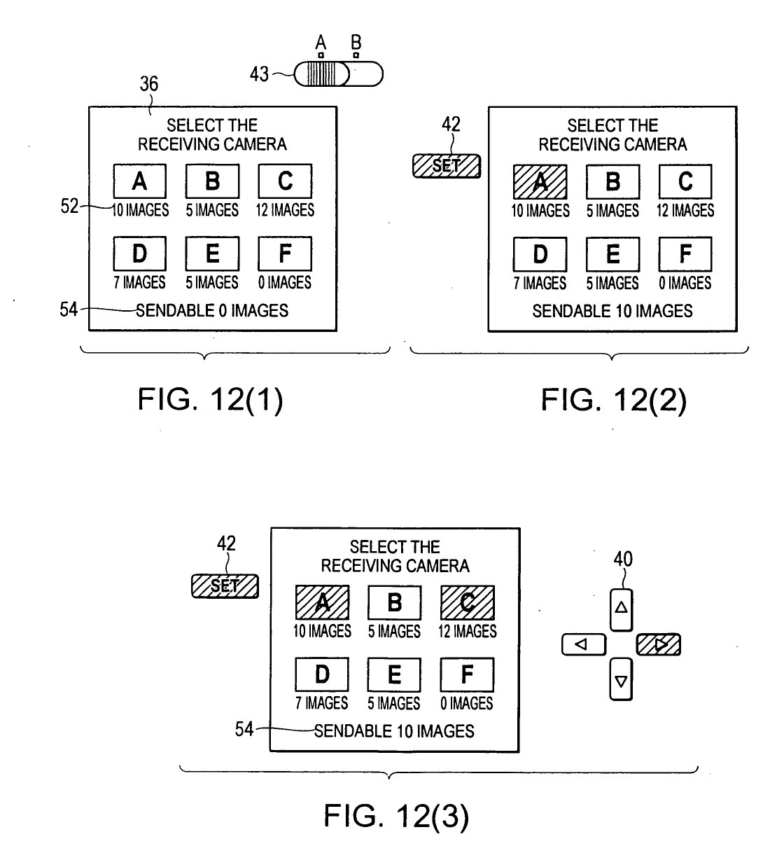

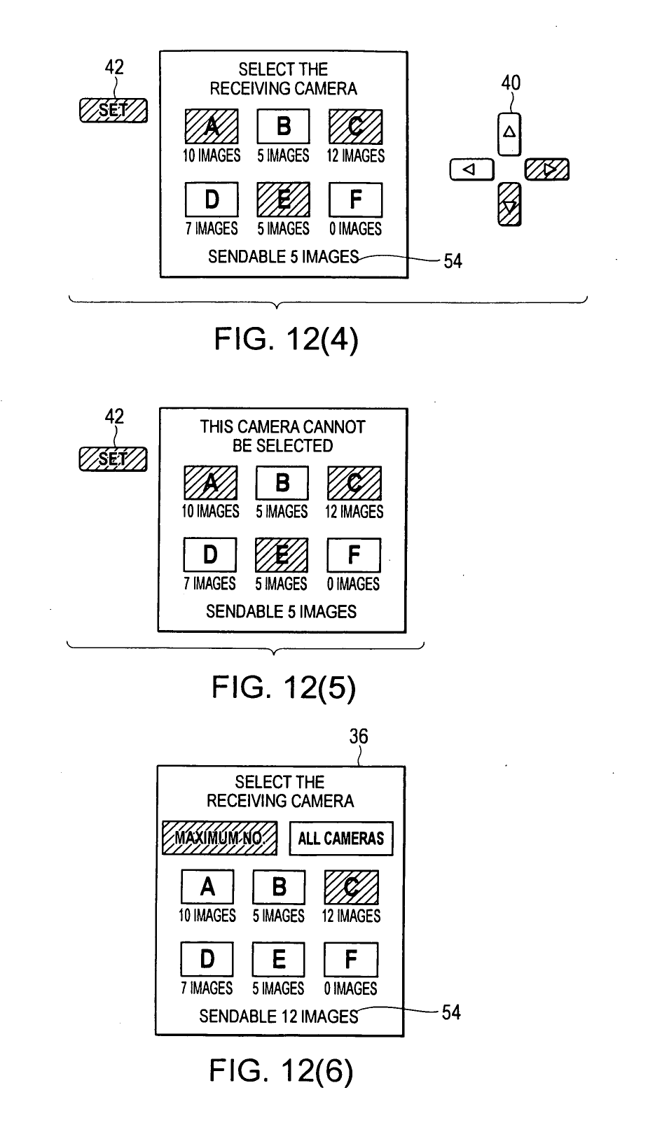

The sender side camera 10 calculates the number of sendable images when it receives the remaining capacity data of the image memory from each receiver side camera (step S105), then displays this number in area 52 on the display 36 (step S106). See FIG. 12(1). Additionally, the minimum number of sendable images from the selected cameras is displayed in column 54. Since initially no cameras are selected, this number is “0”.

Flow then proceeds to step S107. In step S107, selection is made between camera selection mode and image selection mode. If camera selection mode is selected, flow proceeds to step S108. In step S108, either an automatic camera selection mode or a manual selection mode is selected. The manual selection mode, by which one or more receiver side cameras are selected, is now described with reference to FIG. 11, for a camera selection example of FIGS. 12(1)-12(5). Basically, in a manner similar to the image selection process described earlier, the user manipulates cross-configured keys 40 and set key 42 to move between and then select one or more receiver side cameras (steps S109, S110, S111, S112).

In FIG. 12(2), the camera A is selected, and the number of images which are sendable to all the cameras which have been selected so far is displayed at the column 54 (step S113). In the state of FIG. 12(2), only camera A has been selected, and therefore, the 10 sendable images of camera A are displayed in the column 54. Additionally, the icon of the camera A is changed to the shaded condition. Assume that, as shown in FIG. 12(3), the selection of camera C is added. Since camera C has 12 sendable images, the column 54 stays as 10 images. (In other words, 10 images can be received by both cameras, since camera A can only receive 10 images.) At FIG. 12(4), the selection of the camera E is added, and at the column 54, 5 images, which are the sendable images of the camera E, are displayed. Thus, column 54 indicates that 5 images can be sent to all of the selected cameras.

As described above, by making possible the selection of a plurality of cameras and displaying the number of images sendable to all the cameras (the minimum receivable number from all selected cameras), the user can select the cameras in consideration of the number of image(s) which is(are) desired to be transmitted.

In the present embodiment, as shown in FIG. 12(5), when the camera F, which has 0 sendable images, is attempted to be selected by the set key 42, since it is unable to receive any images, the warning message of “this camera cannot be selected” is shown, or the user is advised that the selection of the camera is prohibited by making no change to the display condition of the icon of the camera or the like even when the set key 42 is actuated.

FIG. 12(6) shows another example of the display screen 36. In this example, an automatic selection mode is selected. The first automatic setting is a “maximum images” mode. This mode automatically selects the camera having the maximum remaining capacity within the receiver side cameras. Alternatively, an “all cameras” mode can be selected which automatically selects all the cameras. After an automatic mode is selected, flow proceeds to step S113 to calculate and display the sendable number of images.

As described above, the selection of all cameras is carried out by default, but by selecting “maximum number of images” at the screen of FIG. 12(6), the camera C which has maximum capacity is automatically selected, and the number of sendable images “12” of the camera C is displayed at the column 54. This selection is used in an emergency when the user wants to evacuate as much image data as possible from the image memory of the sender side camera or the like.

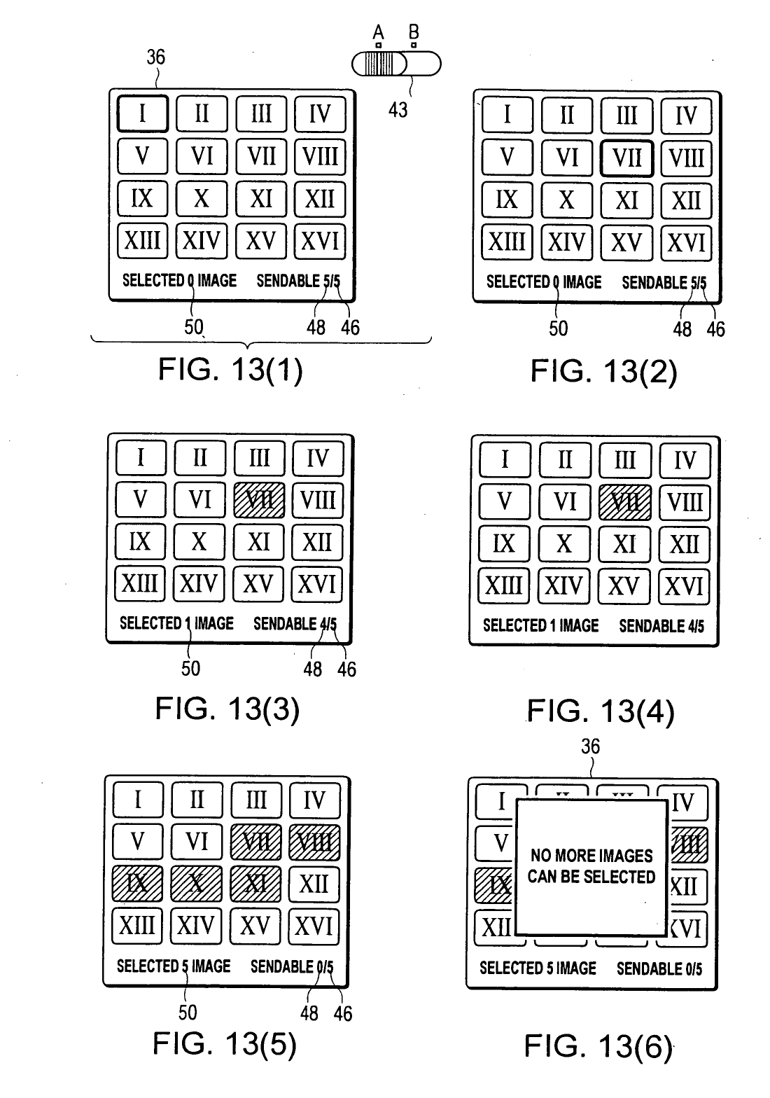

FIGS. 13(1)-13(6) show the display screen when set to the image selection mode. When the mode switching key 43 is set to “A”, the image selection mode screen is displayed on the display screen. Here, assume that the camera is shifted to the image selection mode after the cameras A, C and E are selected as shown in FIG. 12(4). Accordingly, at FIG. 13(1), the number of sendable images is displayed as “5” in column 46. As for the selection of the images, the selection becomes effective by shifting the thickened peripheral frame by using the cross-configured keys 40 the same as for the camera selection and by pressing the set key 42 (steps S115, S116 and S117). See FIG. 13(2).

However, in the case of the image selection, when the set key 42 is pressed, the determination of whether the number of selected images exceeds the number of the sendable images is carried out by the microprocessor 30 (step S118) so that images will not be selected beyond the number of sendable images. When the number of sendable images is not exceeded, the selection of the image(s) to be sent becomes effective, and a shaded display is given to the icon of the selected image as shown in FIG. 13(3) (step S119). When the number of the sendable images is exceeded, the warning message “no more images can be selected” is displayed as shown in FIG. 13(6), or a warning is given by prohibiting the shading display of the icon of the image even when the set key 42 is pressed (step S120).

If all the images desired to be sent cannot be sent due to a limitation of the number of the sendable images, the user can re-select the camera(s) through steps S108 to the step S112 by entering the camera selection mode again. In that case, the selected image(s) at the above-mentioned image selection mode are stored so that it is not necessary to perform the image selection again. Additionally, when the user returns to the image selection mode after the re-selection of the camera, the aforementioned selected image(s) is(are) displayed on the display screen in the selected state. Accordingly, the user can add or delete the optional screen.

In the flow chart of FIG. 11, the image selection mode may be executed before selecting the camera. In that case, as described above, the number of sendable images which can be sent to all the cameras is displayed in the sendable image number column 46. When that number is too small, by designating the camera selection mode, the setting of the maximum sendable camera(s) or the selection of a camera by manual operation is performed. The user can go back and forth between the image selection mode and the camera selection mode for the necessary number of times. By doing this, the flexible selecting of the receiver cameras and the image(s) to be sent becomes possible.

Finally, when the send key 44 is pressed (step S121), the image data which is selected in the sender side camera is transferred to the receiver side camera(s). When receipt is completed, the receipt confirmation signal is sent from the receiver side camera(s), and the sender side camera receives the receipt confirmation signal from all the cameras selected (step S122). In transfer of the image data, since the selected camera does not select images beyond the number of receivable images, a communication error due to the lack of the capacity of the image data memory of the receiver side can be prevented.

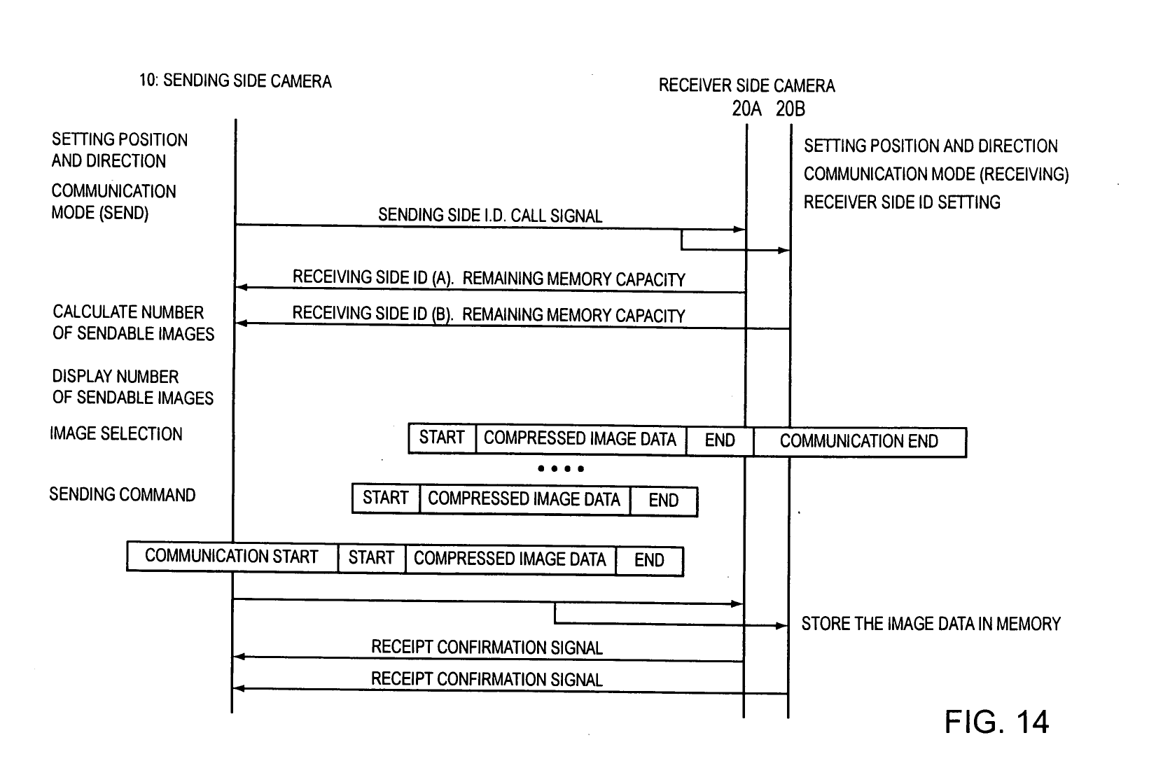

FIG. 14 illustrates transmission of the image data between cameras. In this figure, the sender side camera 10 is shown at the left side, the receiver side cameras 20A and 20B are shown at the right side, the operations of the sender side camera are shown at the left end, the operations of the receiver side cameras are shown at the right end and one example of communication data between both cameras is shown at the center. Top to bottom is the time direction in the figure.

First, the position and the direction of both cameras are manually set in the state of FIG. 9. Then the sending side camera is set to the sending mode of the communication mode by the mode setting switch 8. The receiver side cameras are set to the receiving mode of the communication mode, by the mode setting switch 8. At the receiving side, when there is a plurality of cameras, the setting of ID is performed through a display screen, which is not shown in the figure.

Therefore, from the sending side camera, the ID data and CALL signal of the sender side are sent by infrared beam. Each receiver side camera returns the receiver side ID and the remaining capacity data of the image memory time sequentially in the order of the individually set ID data at the time of receiving the CALL signal. The sender side camera 10 receives this data, calculates the number of image(s) which is(are) receivable by each receiver side camera and displays it as the number of sendable images (area 52 in FIG. 12(1)). Based on this information, the aforementioned camera selection mode and image selection mode are executed, and the selection of the image(s) to be sent and of the receiver side camera(s) are performed.

After this, when the sending order is given by the send key 44, the compressed image data interposed between the communication starting code and the communication end code are inserted only for the selected number of images and are sent by optical communication from the sender side camera 10. In the communication starting code is included the ID data of the (or each) selected receiver side camera. Each receiver side camera which has received its own ID stores the received compressed image data in its image memory, and that storing is reflected in the file allocation table. Then, each selected camera returns the receipt confirmation signal to the sender side camera time sequentially.

At the time of sending this image data, in order to show to the user which camera receives the image data, the red-eye reduction lamp 6 or the self timer lamp 7 of the receiver side, for example, are flashed. Or these lamps flash when the camera is selected in the camera selection mode.

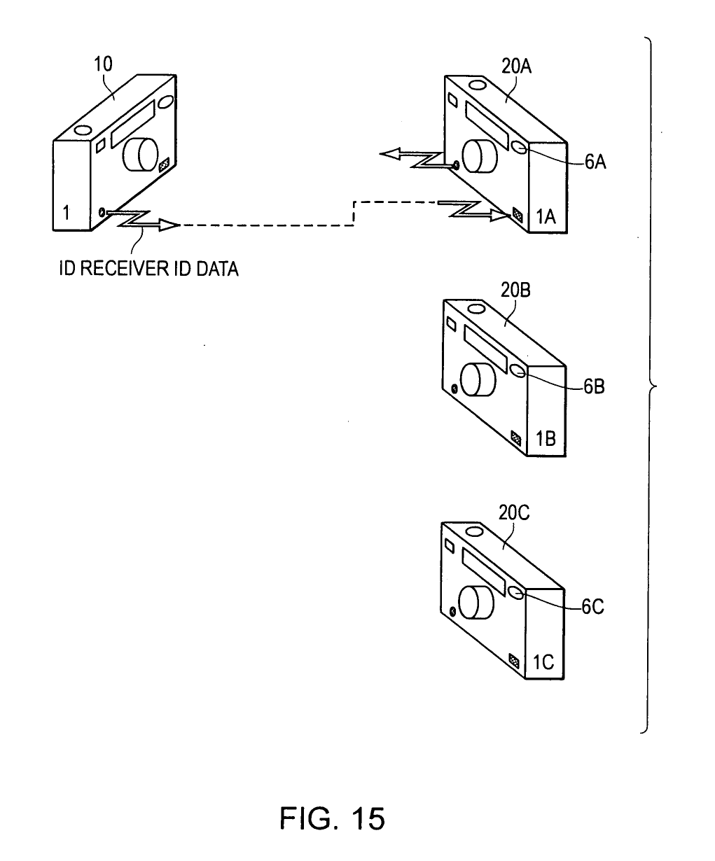

FIG. 15 shows the condition when only the receiver side camera 20A is selected among three receiver side cameras 20A, 20B and 20C, and it shows that camera 20A is selected by flashing only the red-eye reduction lamp 6A of the camera 20A.

In the present embodiment explained above, the case when the image(s) is(are) sent to a plurality of cameras by the optical communication of the infrared beam is explained. However, the present invention is not limited to the optical communication by infrared beam, and it is also applicable with other optical medium communications. Moreover, it is also applicable to connecting with a communication cable (and transmission optically, electrically or otherwise).

As explained above, in one aspect of the present invention, when the image data is transferred between cameras, the sender side camera receives the capacity of the receivable image data of the receiver side camera before starting the transmission, and displays the corresponding number of sendable images on the sender side camera display. Thus, the transfer of image data beyond the remaining capacity of the receiver side image data memory can be prevented. Moreover, at the sender side camera, by prohibiting the selection of image data that exceeds the remaining capacity of the receiver side, the image data with receivable capacity can be reliably selected and transferred to the receiver side camera(s). Accordingly, the occurrence of a transmission error in the transmission of the image data can be prevented beforehand.

As explained above, according to an aspect of the present invention, in an electronic still camera, when the image data is sent to a plurality of cameras, selecting the image beyond the number of the receivable images at the receiver camera side is prevented, and the occurrence of a transmission error of the image data can be prevented. Moreover, since the number of the receivable image(s) is(are) controlled, it is possible to control the number of the images that all of the plurality of cameras can receive, all the selected images can be sent to all the selected cameras. Accordingly, the occurrence of an error to part of the cameras and the occurrence of an error to part of the images can be prevented.

Moreover, since the camera can alternately go back and forth between the camera selection mode and the image selection mode, the image transfer can be performed with higher flexibility.

The camera controller can be implemented as a single special purpose integrated circuit (e.g., ASIC) having a main or central processor section for overall, system-level control, and separate sections dedicated to performing various different specific computations, functions and other processes under control of the central processor section. It will be appreciated by those skilled in the art that the controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flowcharts shown in FIGS. 5 and 11 can be used as the controller. A distributed processing architecture may be preferred for maximum data/signal processing capability and speed.

The manner in which the user interface appears and functions is just one example. For example, the setting and selection of image files can be shown by highlighting or otherwise distinguishing one image from others any number of different ways. Additionally, the user can input commands by means other than by manipulation of keys. For example, a touch pad or a cursor movable by a mouse, track ball or track pad can be used.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention.

What is claimed is:

1. An electronic camera having an image data memory for storing image data and operable in a communication mode for transmitting the image data from the image data memory to a different, receiver side camera, the electronic camera comprising:
a controller that, prior to image data transmission, receives remaining capacity data relating to an amount of a remaining capacity of an image data memory of a receiver side camera and displays a number of the image data which can be transmitted to the receiver side camera based on the remaining capacity of the receiver side camera which has been received by the controller.
